(19) United States
(12) Patent Application Publication
(10) Pub. No.: US 2012/0226206 A1
(43) Pub. Date: Sep. 6, 2012

(54) GUM MASSAGING DEVICE

(76) Inventor: CHIEN-FENG LIN, New Taipei City (TW)

(21) Appl. No.: 13/404,179

(22) Filed: Feb. 24, 2012

(30) Foreign Application Priority Data
Mar. 3, 2011 (TW) 100203673

(51) Int. Cl. A61H 13/00

(52) U.S. Cl. 601/140

(57) ABSTRACT

A gum massaging device includes upper and lower curve plates and upper and lower massage plates. The upper and lower curve plates are used for contacting upper and lower rows of teeth once the gum massaging device is inserted into a mouth of a user. The upper and lower curve plates have C-shaped structures with inner ends connected to each other and outer ends spaced apart from each other so as to define a gap between the outer ends. The upper and lower massage plates are mounted respectively on the upper and lower curve plates in such a manner that the upper and lower massage plates are adapted to contact upper and lower gums of the upper and lower rows of teeth to provide massaging effects once the upper and lower massage plates are pressed against the upper and lower gums.

### BACKGROUND OF THE INVENTION

1. Field of the Invention

The present invention relates to a massaging device, more particularly to a massaging device, which is adapted to massage the gum of a user and which is adapted to simultaneously clean the teeth of the user.

2. Description of the Prior Art

How to maintain the teeth to be health is common knowledge, which should not be neglected by the majority people of the modern age. In addition to brush our teeth daily, we should cultivate the habit of cleaning our mouth immediately after each meal so as to maintain the mouth in hygienic ways. Hence, a portable auxiliary kit is necessary to be taken along with us so that we can scrap the tongue and clean the teeth only then we can keep our mouth clean at the finest condition, i.e., orally cleaning the mouth.

As far as the oral diseases are concerned, gingivitis is the most common ones the adults encounter in addition to tooth decay, since severe gingivitis may lead to shrinkage of the gum or gingival bleeding. The majority of the people place emphasis in brushing the teeth, little people may notice cleaning the gum is also important. Some dentists may suggest the patients to note cleaning of the gum and that massage to the gum is helpful in addition to generally brushing the teeth. At home, we can do simple massage to the gum or buy special oral solution for gargling the mouth so as to irritate the gum, thereby leading our teeth and gum to healthy condition and simultaneously reducing gum inflammation in case we suffer from minor gingivitis, generally call gum disease.

The gum massage method generally includes pressing the marginal ridges of teeth by means of toothbrush, water injection is another one, pressing against the marginal ridges of teeth with ones' fingers is yet another way. Over stiffness in the bristles of the toothbrush may cause gingival bleeding while water injection may wet the user's clothes. Unhygienic fingers may bring undesired effects to the healthy mouth of a person.

### SUMMARY OF THE INVENTION

Therefore, the main object of the present invention is to provide to a massaging device, which is adapted to massage the marginal ridges of the teeth of a user and which is adapted to simultaneously clean the teeth of the user.

A massaging device of the present invention includes upper and lower curve plates and upper and lower curve plates. The upper and lower curve plates are adapted to be contact with upper and lower rows of teeth once the massaging device is inserted into a mouth of a user. The upper and lower curve plates have C-shaped structures with inner ends connected to each other and outer ends spaced apart from each other so as to define a gap between the outer ends. The upper and lower massage plates are mounted respectively on the upper and lower curve plates in such a manner that the upper and lower massage plates are adapted to contact with upper and lower gums of the upper and lower rows of teeth to provide massaging effects once the upper and lower massage plates are pressed against the upper and lower gums. Preferably, the upper and lower massage plates have inner surfaces formed with a plurality of protrusions for pressing manually by the user against the upper and lower gums of the upper and lower rows of teeth so as to enhance blood circulation at the gingiva. The upper and lower curve plates and massage plates cooperatively defining adjoining areas provided with a plurality of bristles for cleansing the gingiva, hence providing hygienic and healthy teeth to the user.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a perspective view of the first embodiment of a massaging device of the present invention for teeth;

FIG. 2 is a lateral side view of the first embodiment of the massaging device of the present invention for teeth;

FIG. 3 shows a perspective view of the second embodiment of the massaging device of the present invention for teeth;

FIG. 4 is an exploded view of the second embodiment of the massaging device of the present invention for teeth;

FIG. 5 is an exploded view of the third embodiment of the massaging device of the present invention for teeth;

FIG. 6 is an exploded view of the fourth embodiment of the massaging device of the present invention for teeth;

FIG. 7 illustrates the massaging device of the present invention in application;

FIG. 8 is a lateral side view of the fourth embodiment of the massaging device of the present invention for teeth;

FIG. 9 illustrates the fourth embodiment of the massaging device of the present invention in application;

FIG. 10 illustrates a perspective view of the fifth embodiment of the massaging device of the present invention for teeth;

FIG. 11 shows a lateral side view of the sixth embodiment of the massaging device of the present invention for teeth; and

FIG. 12 shows a perspective view of the seventh embodiment of the massaging device of the present invention for teeth.

### DETAILED DESCRIPTION OF THE PREFERRED EMBODIMENTS

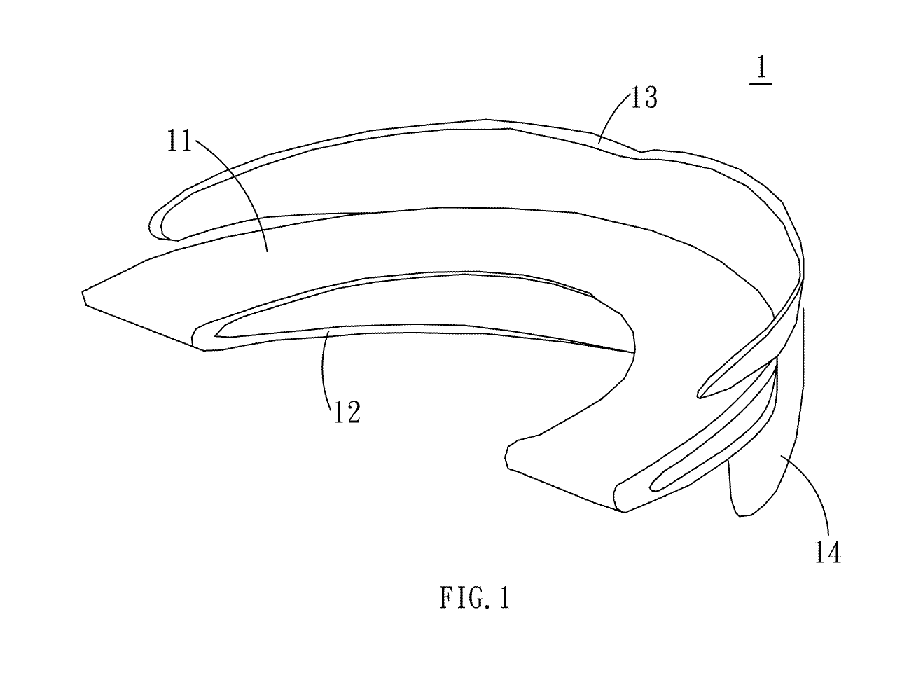

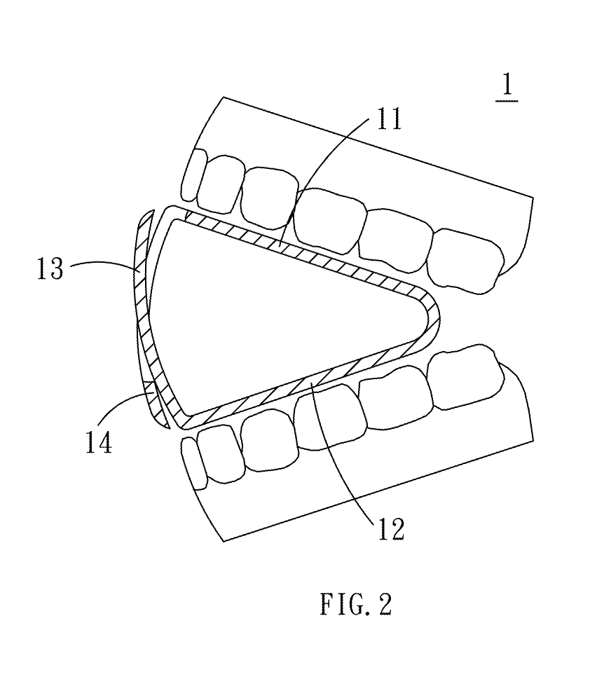

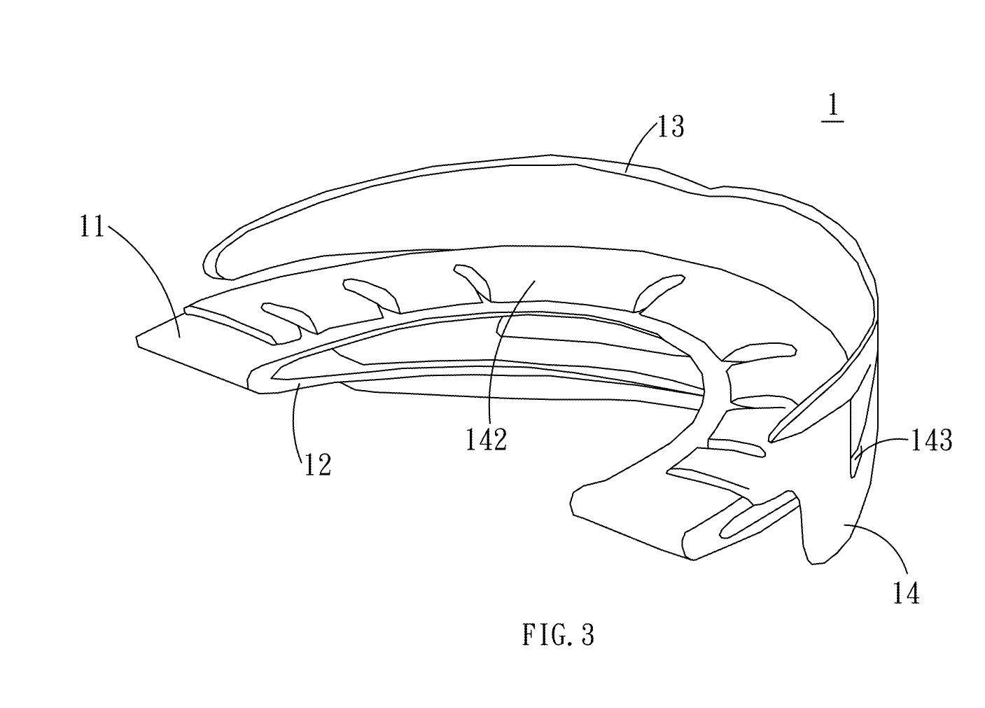

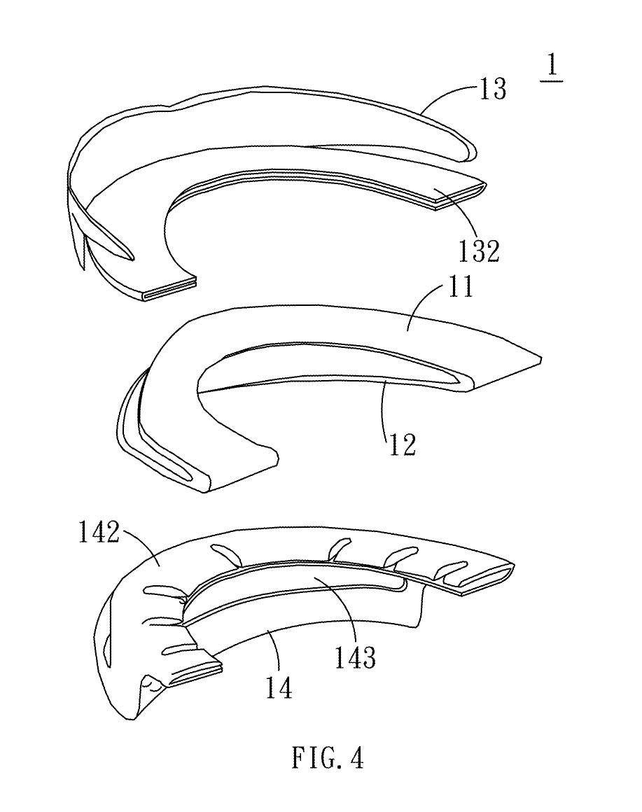

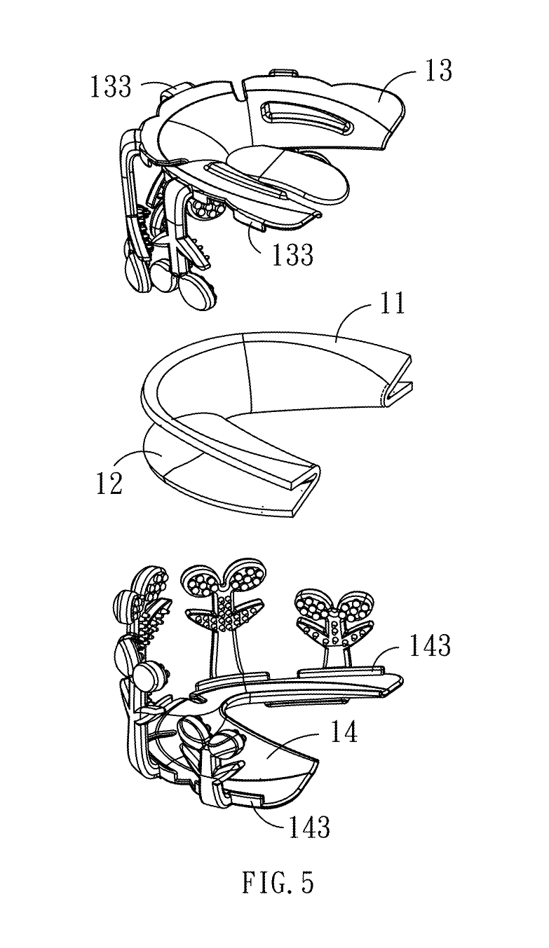

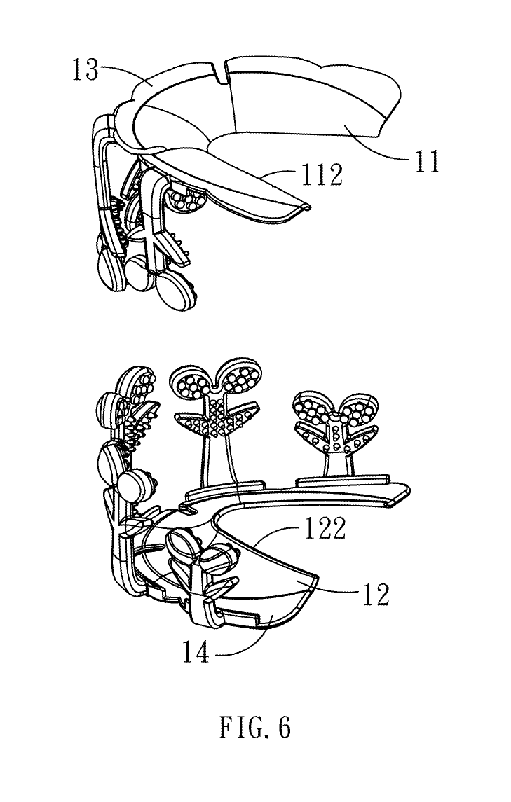

Referring to FIGS. 1 and 2, wherein FIG. 1 shows a perspective view of the first embodiment of a massaging device of the present invention for teeth while FIG. 2 is a lateral side view of the first embodiment of the massaging device of the present invention for teeth. The massaging device 1 of the present invention includes upper and lower curve plates 11, 12 and upper and lower massage plates 13, 14. The upper and lower curve plates 11, 12 are adapted to be contact with upper and lower rows of teeth once the massaging device 1 is inserted into a mouth of a user. The upper and lower curve plates 11, 12 have C-shaped structures with inner ends connected to each other and outer ends spaced apart from each other so as to define a gap between the outer ends. The upper and lower massage plates 13, 14 are mounted respectively on the upper and lower curve plates 11, 12 in such a manner that the upper and lower massage plates 13, 14 are adapted to contact with upper and lower gums of the upper and lower rows of teeth to provide massaging effects once the upper and lower massage plates 13, 14 are pressed against the upper and lower gums. Preferably, the upper and lower curve plates 11, 12 and the upper and lower massage plates 13, 14 are integrally formed with each other or separated from each other. FIG. 3 shows a perspective view of the second embodiment of the massaging device of the present invention for teeth while FIG. 4 is an exploded view of the second embodiment of the massaging device of the present invention for teeth. As illustrated, the upper massage plate 13 has a fixing section 132 fixed securely to the upper curve plate 11 while the lower massage plate 14 has a fixing section 142 fixed securely to the lower curve plate 12 in such a manner that the upper and lower massage plates 13, 14 extend transversely relative to each other. The lower massage plate 14 is preferably formed an access opening 143 for extension of the upper massage plate 13. Of course, the upper massage plate 13 can be formed an access opening for extension of the lower massage plate 14. Alternately, FIG. 5 shows an exploded view of the third embodiment of the massaging device of the present invention for teeth. As shown, the upper massage plate 13 has a plurality of engagement elements 133 for fixing on the upper curve plate 11 while the lower massage plate 14 has a plurality of engagement elements 143 for fixing on the lower curve plate 12. FIG. 6 shows an exploded view of the fourth embodiment of the massaging device of the present invention for teeth, wherein the upper curve plate 11 and the upper massage plate 13 are integrally formed with each other while the lower curve plate 12 and the lower massage plate 14 are integrally formed with each other. In the same manner, the inner ends 112, 122 of the upper and lower curve plates 11, 12 are connected to each other by pressing means.

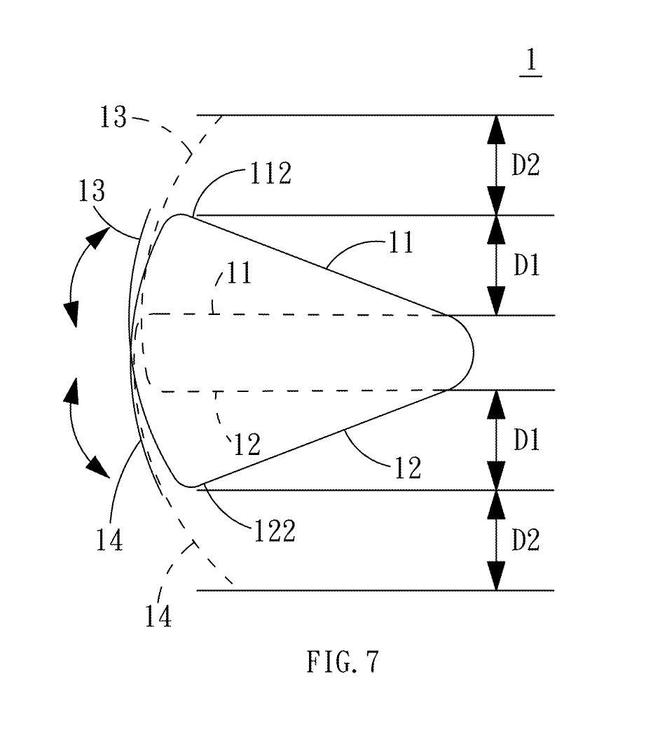

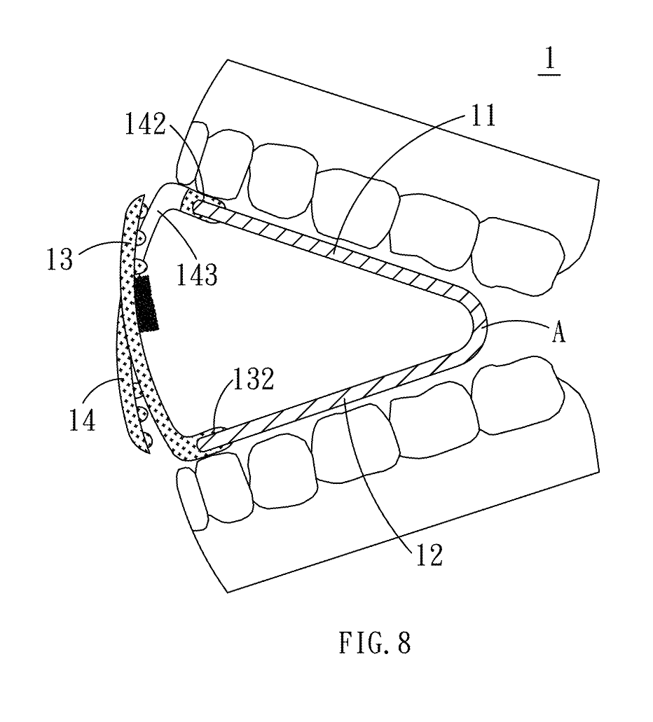

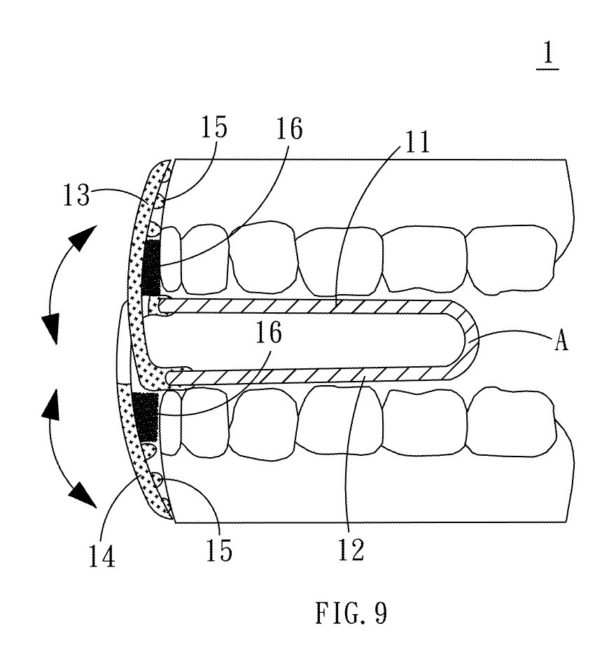

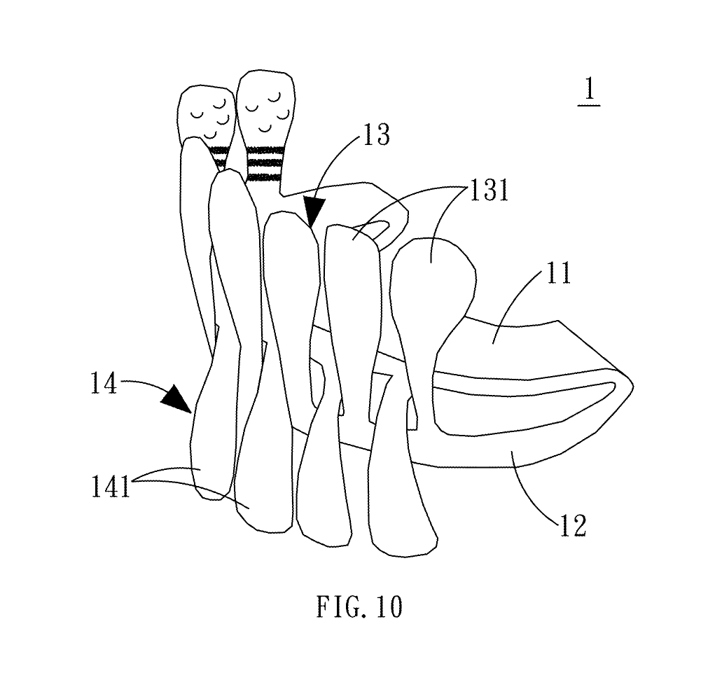

In this embodiment, each of the upper and lower massage plates 13, 14 is made from Ethylene vinyl acetate (EVA) material so that prior to application (i.e., before inserting into the mouth of the user), the massaging device 1 of the present invention is pre-heated so as to soften the same, such as immersing within the hot water of 60° C. in order to soften the device slightly. Once inserted into the user's mouth and being clamped by the user's teeth, the massaging device 1 returns to its initial temperature. At this time and as illustrated in FIG. 7, the upper and lower curve plates 11, 12 move a distance (D1) relative to each other, wherein the upper and lower massage plates 13, 14 consequently move a distance (D2), where (D1)=(D2) so that the upper and lower massage plates 13, 14 can be pressed against the upper and lower gums of the upper and lower rows of the user's teeth. Upon release of the clamping force exerted by the user's teeth, the massaging device 1 of the present invention regains its initial shape due to its restoration force of the constructed material. FIG. 8 is a lateral side view of the fourth embodiment of the massaging device of the present invention for teeth. The fourth embodiment has the structure similar to the second embodiment shown in FIG. 4. The only difference resides in that the upper massage plate 13 has a fixing section 132 fixed securely to the lower curve plate 12 while the lower massage plate 14 has a fixing section 142 fixed securely to the upper curve plate 11 in such a manner that the upper and lower massage plates 13, 14 extend transversely relative to each other through the access opening 143. Under such a situation and as illustrated in FIGS. 8 and 9, during the restoration of the massaging device 1 of the present invention (i.e., upon release of the clamping force exerted by biting teeth of the user), the upper and lower massage plates 13, 14 massage the upper and lower gums respectively. Preferably, the upper and lower massage plates 13, 14 have inner surfaces formed with a plurality of protrusions 15 (see FIG. 9) for pressing against the upper and lower gums. In addition, the upper and lower curve plates 11, 12 and massage plates 13, 14 cooperatively define adjoining areas provided with a plurality of bristles 16, which clean the teeth of the user during relative movements between the upper and lower curve plates 11, 12. Alternately, the upper and lower curve plates 11, 12 and the massage plates 13, 14 cooperatively defining adjoining areas provided with a plurality of resilient sharp protrusions, each having a longitudinal length greater that each of the protrusions 15 such the resilient sharp protrusions provide cleansing action relative to the teeth of the user during relative movements between the upper and lower curve plates 11, 12 (i.e., relative movement between the upper and lower massage plates 13, 14). FIG. 10 illustrates a perspective view of the fifth embodiment of the massaging device of the present invention for teeth. Of course, the upper and lower massage plates 13, 14 respectively have a plurality of upward and downward elongated massage straps 131, 141 disposed alternately relative to one another, as best shown in FIG. 10, for massaging the upper and lower gums of the user during relative movements between the upper and lower curve plates 11, 12.

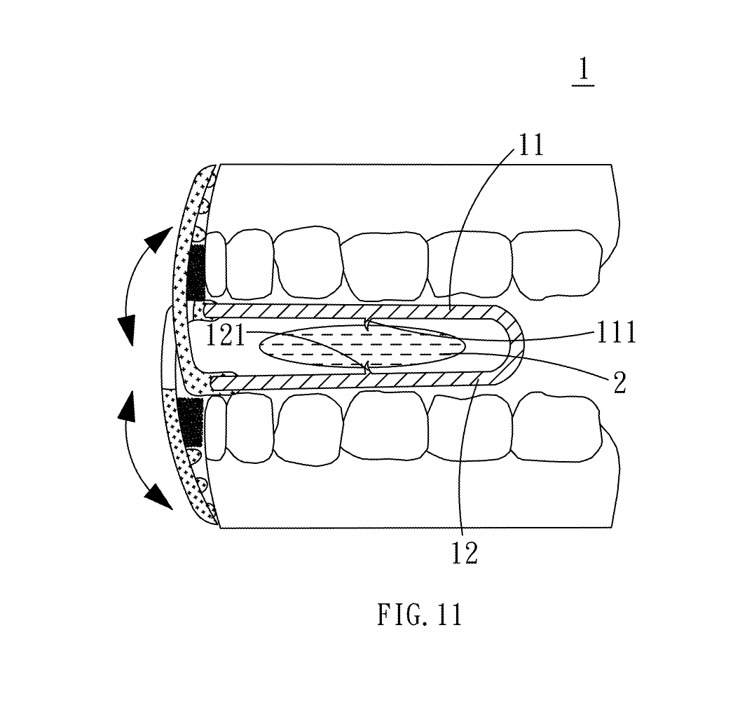

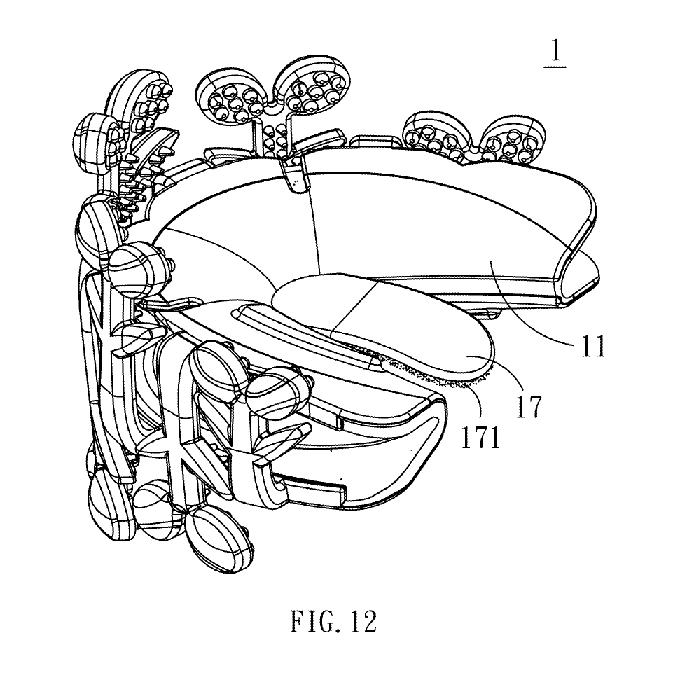

Referring to FIGS. 11 and 12, wherein FIG. 11 shows a lateral side view of the sixth embodiment of the massaging device of the present invention for teeth while FIG. 12 shows a perspective view of the seventh embodiment of the massaging device of the present invention for teeth. As shown, the upper curve plate 11 has a bottom side formed with a sharp downward projection 111 while the lower curve plate 12 has a top side formed with a sharp upward projection 121. After the user gargles his mouth with a cleansing solution, the bubbles resulted after the gargling action are punctured by the sharp projections 111, 112 during relative movements between the upper and lower curve plates 11, 12, which, in turn, circles the cleansing solution once again within the user mouth to enhance the cleansing operation of the user's mouth.

Moreover, the upper curve plate 11 further has a bottom side and a tongue scrapper 17 extending rearward from the bottom side for scrapping a tongue of the user. Preferably, the tongue scrapper 17 of the upper curve plate 11 has a plurality of downward bristles 171 for scrapping the tongue of the user so as to keep the tongue of the user at the healthiest state. In addition, each of the upper and lower massage plates 13, 14 is installed with an oscillator. In this embodiment, the oscillator is an ultrasonic oscillator. In another embodiment, the oscillator is a vibration motor, operation of which vibrate the upper and lower massage plates 13, 14, hence the protrusions 15 press against the upper and lower gums, thereby providing the massage effect to enhance blood circulate in and out of the upper and lower gums of the user of the massaging device of the present invention.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A gum massaging device comprising:
upper and lower curve plates adapted to be contact with upper and lower rows of teeth once the gum massaging device is inserted into a mouth of a user, said upper and lower curve plates having C-shaped structures with inner ends connected to each other and outer ends spaced apart from each other so as to define a gap between said outer ends; and
upper and lower massage plates mounted respectively on said upper and lower curve plates in such a manner that said upper and lower massage plates are adapted to contact with upper and lower gums of said upper and lower rows of teeth to provide massaging effects once said upper and lower massage plates are pressed against said upper and lower gums.

2. The gum massaging device according to claim 1, wherein said upper and lower massage plates have inner surfaces formed with a plurality of protrusions for pressing against said upper and lower gums, said upper and lower curve plates and massage plates cooperatively defining adjoining areas provided with a plurality of bristles.

3. The gum massaging device according to claim 1, wherein said upper and lower massage plates have inner surfaces formed with a plurality of protrusions for pressing against said upper and lower gums, said upper and lower curve plates and massage plates cooperatively defining adjoining areas provided with a plurality of resilient sharp protrusions, each having a longitudinal length greater that each of said protrusions.

4. The gum massaging device according to claim 1, wherein said upper curve plate has a bottom side formed with a sharp downward projection.

5. The gum massaging device according to claim 1, wherein said lower curve plate has a top side formed with a sharp upward projection.

6. The gum massaging device according to claim 1, wherein said upper curve plate further has a bottom side and a tongue scrapper extending rearward from said bottom side for scrapping a tongue of the user.

7. The gum massaging device according to claim 6, wherein said tongue scrapper of said upper curve plate has a plurality of downward bristles for scrapping said tongue of the user.

8. The gum massaging device according to claim 1, wherein each of said upper and lower massage plates is installed with an oscillator.

9. The gum massaging device according to claim 8, wherein said oscillator is an ultrasonic oscillator.

10. The gum massaging device according to claim 8, wherein said oscillator is a vibration motor.

11. The gum massaging device according to claim 1, wherein said each of said upper and lower massage plates is made from Ethylene vinyl acetate (EVA) material.

12. The gum massaging device according to claim 1, wherein said upper and lower massage plates respectively have a plurality of upward and downward elongated massage straps disposed alternately relative to one another for massaging said upper and lower gums.

13. The gum massaging device according to claim 1, wherein said upper massage plate has a fixing section fixed securely to said lower curve plate, said lower massage plate having a fixing section fixed securely to said upper curve plate in such a manner that said upper and lower massage plates extend transversely relative to each other, one of said upper and lower massage plates being formed an access opening for extension of the other one of said upper and lower massage plates.

14. The gum massaging device according to claim 1, wherein said upper massage plate has a plurality of engagement elements for fixing securely on said upper curve plate, said lower massage plate having a plurality of engagement elements for fixing securely on said lower curve plate.

15. A gum massaging device comprising:
upper and lower curve plates adapted to be contact with upper and lower rows of teeth of a user once the gum massaging device is inserted into a mouth of the user, said upper and lower curve plates having C-shaped structures with inner ends connected to each other and outer ends spaced apart and movable relative to from each other so as to define a variable gap between said outer ends;
upper and lower massage plates mounted respectively on said upper and lower curve plates; and
a downward circular plate projecting downward from upper curve plate for overlapping said lower massage plate;
wherein, relative movement between said outer ends of upper and lower curve plates results in variation of contact areas between said upper and lower massage plates and upper and lower gums connected respectively to said upper and lower rows of teeth.

16. The gum massaging device according to claim 15, wherein said upper and lower curve plates and said upper and lower massage plates are integrally formed with each other.

17. The gum massaging device according to claim 15, wherein said upper curve plate and said upper massage plate are integrally formed with each other while said lower curve plate and said lower massage plate are integrally formed with each other, said inner ends of said upper and lower curve plates being connected to each other by pressing means.

18. The gum massaging device according to claim 15, said upper massage plate has a fixing section fixed securely to said lower curve plate, said lower massage plate having a fixing section fixed securely to said upper curve plate in such a manner that said upper and lower massage plates extend transversely relative to each other, one of said upper and lower massage plates being formed an access opening for extension of the other one of said upper and lower massage plates.

19. The gum massaging device according to claim 15, wherein said upper massage plate has a plurality of engagement elements for fixing on said upper curve plate, said lower massage plate having a plurality of engagement elements for fixing on said lower curve plate.

20. The gum massaging device according to claim 15, wherein said upper and lower massage plates have inner surfaces formed with a plurality of protrusions for pressing manually by the user against said upper and lower gums, said upper and lower curve plates and massage plates cooperatively defining adjoining areas provided with a plurality of resilient sharp protrusions, each having a longitudinal length greater that each of said protrusions.
